(19) United States
(12) Patent Application Publication
(10) Pub. No.: US 2010/0285847 A1
(43) Pub. Date: Nov. 11, 2010

(54) Cell phone mount

(76) Inventors: Sarah Ann Greer, Holiday, FL (US); Keith Michael Greer, Port Richey, FL (US)

Correspondence Address: SARAH GREER, 3627 Wiltshire Drive, Holiday, FL, 34691, US

(21) Appl. No.: 12/387,885

(22) Filed: May 9, 2009

(51) Int. Cl. H04M 1/04; H04B 1/40

(52) U.S. Cl. 455/573; 455/575.1

(57) ABSTRACT

A means of creation of joy and enjoyment plus self identification during the process of charging a cell phone.

### FIELD OF THE INVENTION

The present invention relates to cell phone charging and display

### BACKGROUND OF THE INVENTION

There is no joy created when recharging the cell phone; currently all cell phone have a utilitarian power connection wire and power supply plug that plugs into an outlet or power strip. Currently there is no emotional response or enjoyment during this process of charging the cell phone. There are no personal identification reactions to the process of cell phone charging, because the utilitarian power connection wire and power supply is generic in nature and does not create identification with the individual cell phone user.

US 2005/0225292 Charger And Recharger Device

U.S. Pat. No. 7,146,195 B2 Hinge Device And Cell Phone Using The Hinge device

US 2007/0015547 A1 Wall Mounted Cell phone Holder

US 2005/0225292 Charger And Recharger Device has several shortcomings to the invention. First the device is too expensive to mass produce, this device has a connection to a source of power, a plurality of connection points, an adapter to provide electrical power, a micro processor, a multi-voltage connecter to adapt the charging power to portable equipment, a plurality of electrical connections. This is six items used to create a recharging power source, this invention uses single switch to adjust the output voltage to required levels, a connection plate to provide a connection from the power supply to the equipment to be charge, by using variable plate types to create a suitable connection, there is a reduction in equipment parts to create a recharging connection. The Charger and Recharger Device has no identification response from the user of the device, because the device is a utilitarian construction and shape, there is no emotional connection established when using the device. The Charger and Recharger device does not house the cell phone during re charging, thereby the user can lose the cell phone and charger when the user forgets where the device is being charged.

U.S. Pat. No. 7,146,195 B2 Hinge Device And Cell Phone Using The Hinge Device has several shortcoming to the invention. First the device is too expensive to mass produce, the device has numerous mechanical connections that attach to the cell phone to provide support. This invention uses a partial cavity to provide support to the device, reducing the number of parts required to support the cell phone. The Hinge device and cell phone is a utilitarian construction and shape, there is no emotional connect established when using the device. There is no means of creating a personal identification with the utilitarian device.

US 2007/0015547 A1 Wall Mounted Cell phone Holder has several shortcoming to the invention, one is that it has limited identification emotional responses from the user of the device, there is only color and a limited area to post a picture to create a limited response from the user. The wall mounted cell phone holder cannot maintain connection between the cell phone. the recharging wire connection from the connection plug at the bottom of the cell phone, the charging power source. With the Force of Gravity the cord will separate from the cell phone and terminate the recharging capabilities. This invention surrounds the device and there is no dangling connection from the cell phone to the power source providing the connection. This invention has a docking cavity that supports the cell phone and maintains the electrical connection during the charging cycle. This invention creates a greater effect of emotional identification and response from the user by having the whole device have form and shape to create emotional connections, rather than a limited picture and color of the holder itself.

It is therefore an object of the invention to create joyous reactions when charging a cell phone through personal identification reactions

It is another object of the invention to provide a wall or surface device to dock the cell phone to be charged

It is another object of the invention to provide a common power source with various cell phone power requirements

It is another object of the invention to create a common recharging area instead of misplacing the cell phone charger

### SUMMARY OF THE INVENTION

A means of creation of joy and enjoyment with self identification during the process of charging a cell phone.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a Variation of the wall mounted recharge unit in a spider form. FIG. 1 number 1 is the power plug to supply power to the cell phone recharge power supply. FIG. 1 number 2 is the power cord to connect the power plug to the power supply. FIG. 1 number 3 is the front side of the cell phone personalized recharge unit. FIG. 1 number 4 is the cavity that allows the cell phone to dock to the personalized recharge unit. FIG. 1 number 5 is the backside of the cell phone recharge personalized unit. FIG. 1 number 6 is the cavity hole that allows the support mount to be inserted into the cell phone recharge personalized unit. FIG. 1 number 7 is the support mount for the personalized recharge unit. FIG. 1 number 8 is the wall mounted screw that attaches the plug to the wall.

FIG. 2 is a perspective view of a Variation of a horizontal mounted recharge unit. FIG. 2 number 9 is a partial view of a table that is supporting the table mounted personalized recharge unit. FIG. 2 number 10 is a partial view of a table leg. FIG. 2 number 11 is a power plug receptacle. FIG. 2 number 12 is the power cord that connects the power plug receptacle to the table mounted personalized recharge unit power supply. FIG. 2 number 13 is the horizontal mounted personalized recharge unit in a turtle variation. FIG. 2 number 14 is the cavity that the cell phone is set into.

FIG. 3 is a perspective view of an interconnecting parts of the personalized recharge unit power supply. FIG. 3 number 15 is the power plug that supplies power to the power supply. FIG. 3 number 16 is the power cord that connects the power plug to the power supply. FIG. 3 number 17 is the power supply. FIG. 3 number 18 is the s1 switch that changes the voltage output to the correct voltage for the cell phone that is to be recharged. FIG. 3 number 19 is the attachment piece that connects the power supply to the interchangeable plate to connect the power plug to the cell phone. FIG. 3 number 20 is the power supply wire that connects the output of the power supply to the cell phone. FIG. 3 number 21 is the interchangeable cell phone plate. FIG. 3 number 22 is the power receptacle that connects the power supply to the cell phone power source input. FIG. 3 number 28 shows the power supply connected to the adapter. FIG. 3 number 27 shows the attachment piece that is interconnected the power supply to the interchangeable cell phone plate. FIG. 3 number 25 shows the interchangeable cell phone plate attached to the attachment piece with the cavity of the cell phone mount. FIG. 3 number 26 is the interior cavity that the cell phone will mount into while recharging. FIG. 3 number 24 is the interior side of the interior cavity of the cell phone wall mount charger. FIG. 3 number 23 is the upper interior side of the interior cavity of the cell phone wall mount personalized recharge unit; and

FIG. 4 is a perspective view of a personalized recharge unit power supply schematic. FIG. 4 number 29 is a interface plate that connects a cell phone power input to the power supply. FIG. 4 number 30 shows a variation of the interface plate that connects a different model of a cell phone power input connection to the power supply. FIG. 4 number 31 shows a variation of the interface plate that connects a different model of a cell phone power input connection to the power supply. FIG. 4 number 33 is a power supply resistor to develop voltage across a voltage divider network. FIG. 4 number 34 is a power supply resister to develop voltage across a voltage divider network. FIG. 4 number 35 is a power supply resister to develop voltage across a voltage divider network. FIG. 4 number 36 is a power supply resister to develop voltage across a voltage divider network. FIG. 4 number 37 is a power supply resister to develop voltage across a voltage divider network. FIG. 4 number 38 is the insulated electrical wire that connects the developed voltage to the s1 switch. FIG. 4 number 39 is the insulated electrical wire that connects the developed voltage to the s1 switch. FIG. 4 number 40 is the insulated electrical wire that is the output of the s1 switch to the output jack that connects to the interface electrical cell phone plate. FIG. 4 number 41 is the jack that connects to the interface electrical cell phone plate. FIG. 4 number 42 is the s1 output switch. FIG. 4 number 43 shows the connection of the power supply voltage circuit path from the power supply through the switch to the interconnecting wire to the output jack. FIG. 4 number 44 is the insulated electrical wire that connects the developed voltage to the s1 switch. FIG. 4 number 45 is the insulated electrical connecting wire to the output jack. FIG. 4 number 46 is the insulated electrical wire that connects the power supply voltage to the s1 switch. FIG. 4 number 57 is the power supply capacitor that smoothes the electrical voltage output. FIG. 4 number 47 is the diode that rectifies the ac voltage to a de voltage. FIG. 4 number 48 is the electrical connections from the power supply to the voltage divider network. FIG. 4 number 49 is the diode that reifies the ac voltage to a dc voltage. FIG. 4 number 49 is the diode that rectifies the ac voltage to a dc voltage. FIG. 4 number 50 is the diode that rectifies the ac voltage to a dc voltage. FIG. 4 number 50 is the diode that rectifies the ac voltage to a dc voltage. FIG. 4 number 51 is the secondary winding of a transformer. FIG. 4 number 52 is the diode that rectifies the ac voltage to a dc voltage. FIG. 4 number 53 is the transformer core. FIG. 4 number 54 is the primary transformer. FIG. 4 number 55 is the insulated electrical wire that connects the plug to the power supply. FIG. 4 number 56 is an insulated electrical plug.

For purposes of clarity and brevity, like elements and components will bear the same designations and numbering throughout the FIGURES.

### DESCRIPTION OF THE PREFERRED EMBODIMENT

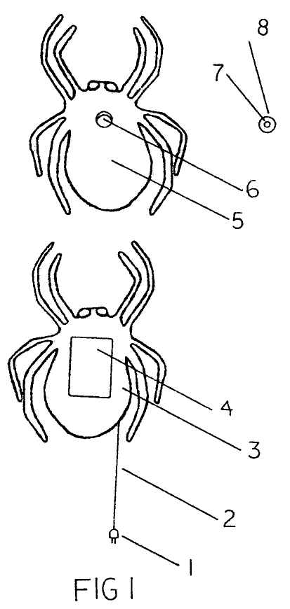

FIG. 1 is a perspective view of a Variation of the wall mounted recharger unit in a spider form. FIG. 1 number 1 is the power plug to supply power to the cell phone recharge power supply 16. FIG. 1 number 2 is the power cord 18 to connect the power plug to the power supply 16. FIG. 1 number 3 is the front side of the cell phone personalized recharge unit 10. FIG. 1 number 4 is the cavity that allows the cell phone to dock to the personalized recharge unit 10. FIG. 1 number 5 is the backside of the cell phone recharge personalized unit. FIG. 1 number 6 is the cavity hole that allows the wall mounted plug to be inserted into the cell phone recharge personalized unit. FIG. 1 number 7 is the support mount 20 for the personalized recharge unit 10. FIG. 1 number 8 is the wall mounted screw that attaches the plug to the wall.

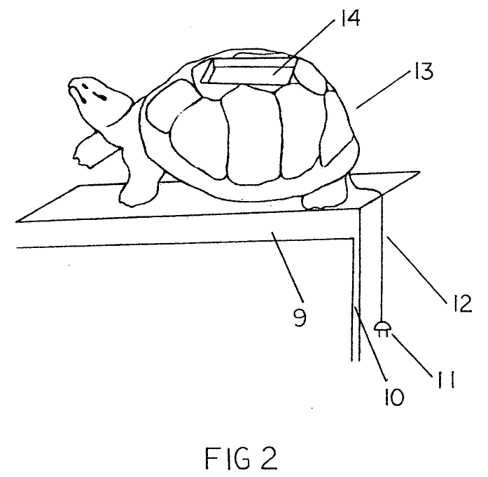

FIG. 2 is a perspective view of a Variation of a horizontal mounted recharge unit. FIG. 2 number 9 is a partial view of a table that is supporting the table mounted personalized recharge unit 10. FIG. 2 number 10 is a partial view of a table leg. FIG. 2 number 11 is a power plug receptacle. FIG. 2 number 12 is the power cord 18 that connects the power plug receptacle to the table mounted personalized recharge unit 10 power supply 16. FIG. 2 number 13 is the horizontal mounted personalized recharge unit 10 in a turtle variation. FIG. 2 number 14 is the cavity that the cell phone is set into.

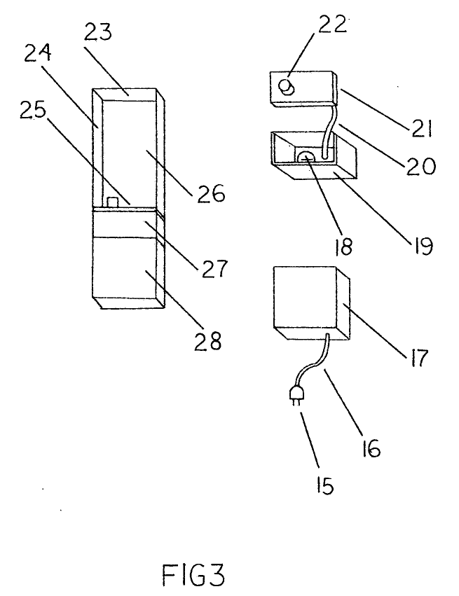

FIG. 3 is a perspective view of an interconnecting parts of the personalized recharge unit 10 power supply 16. FIG. 3 number 15 is the power plug that supplies power to the power supply 16. FIG. 3 number 16 is the power cord 18 that connects the power plug to the power supply 16. FIG. 3 number 17 is the power supply 16. FIG. 3 number 18 is the s1 switch that changes the voltage output to the correct voltage for the cell phone that is to be recharged. FIG. 3 number 19 is the attachment piece that connects the power supply 16 to the interchangeable plate to connect the power plug to the cell phone. FIG. 3 number 20 is the power supply 16 wire that connects the output of the power supply 16 to the cell phone. FIG. 3 number 21 is the interchangeable cell phone plate. FIG. 3 number 22 is the power receptacle that connects the power supply 16 to the cell phone power source input. FIG. 3 number 28 shows the power supply 16 connected to the adapter. FIG. 3 number 27 shows the attachment piece that is interconnected the power supply 16 to the interchangeable cell phone plate. FIG. 3 number 25 shows the interchangeable cell phone plate attached to the attachment piece with the cavity of the cell phone mount. FIG. 3 number 26 is the interior cavity 12 that the cell phone will mount into while recharging. FIG. 3 number 24 is the interior side of the interior cavity 12 of the cell phone wall mount charger. FIG. 3 number 23 is the upper interior side of the interior cavity 12 of the cell phone wall mount personalized recharge unit 10.

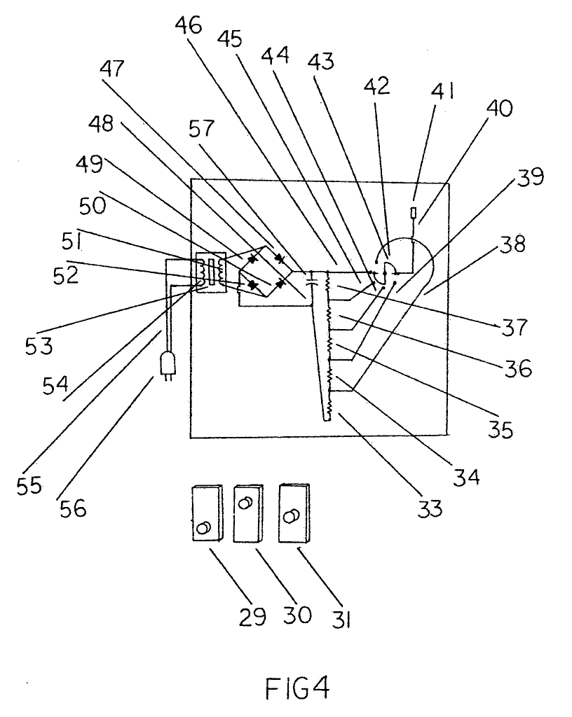

FIG. 4 is a perspective view of a personalized recharge unit 10 power supply 16 schematic. FIG. 4 number 29 is a interface plate 14 that connects a cell phone power input to the power supply 16. FIG. 4 number 30 shows a variation of the interface plate 14 that connects a different model of a cell phone power input connection to the power supply 16. FIG. 4 number 31 shows a variation of the interface plate 14 that connects a different model of a cell phone power input connection to the power supply 16. FIG. 4 number 33 is a power supply 16 resistor to develop voltage across a voltage divider network. FIG. 4 number 34 is a power supply 16 resister to develop voltage across a voltage divider network. FIG. 4 number 35 is a power supply 16 resister to develop voltage across a voltage divider network. FIG. 4 number 36 is a power supply 16 resister to develop voltage across a voltage divider network. FIG. 4 number 37 is a power supply 16 resister to develop voltage across a voltage divider network. FIG. 4 number 38 is the insulated electrical wire that connects the developed voltage to the s1 switch. FIG. 4 number 39 is the insulated electrical wire that connects the developed voltage to the s1 switch. FIG. 4 number 40 is the insulated electrical wire that is the output of the s1 switch to the output jack that connects to the interface electrical cell phone plate. FIG. 4 number 41 is the jack that connects to the interface electrical cell phone plate. FIG. 4 number 42 is the s1 output switch. FIG. 4 number 43 shows the connection of the power supply 16 voltage circuit path from the power supply 16 through the switch to the interconnecting wire to the output jack. FIG. 4 number 44 is the insulated electrical wire that connects the developed voltage to the s1 switch. FIG. 4 number 45 is the insulated electrical connecting wire to the output jack. FIG. 4 number 46 is the insulated electrical wire that connects the power supply 16 voltage to the s1 switch. FIG. 4 number 57 is the power supply 16 capacitor that smoothes the electrical voltage output. FIG. 4 number 47 is the diode that rectifies the ac voltage to a de voltage. FIG. 4 number 48 is the electrical connections from the power supply 16 to the voltage divider network. FIG. 4 number 49 is the diode that reifies the ac voltage to a dc voltage. FIG. 4 number 49 is the diode that rectifies the ac voltage to a dc voltage. FIG. 4 number 50 is the diode that rectifies the ac voltage to a dc voltage. FIG. 4 number 50 is the diode that rectifies the ac voltage to a dc voltage. FIG. 4 number 51 is the secondary winding of a transformer. FIG. 4 number 52 is the diode that rectifies the ac voltage to a dc voltage. FIG. 4 number 53 is the transformer core. FIG. 4 number 54 is the primary transformer. FIG. 4 number 55 is the insulated electrical wire that connects the plug to the power supply 16. FIG. 4 number 56 is an insulated electrical plug.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A cell phone mount for docking and recharging a cellphone comprising:
means for support and recharging a cell phone with personalization;
means for provide partial enclosure of the cellphone and access to the power supply connection, structurally conformed to said means for support and recharging a cell phone with personalization;
means for provide electrical connection for various cell phone models, directly fitted to said means for provide partial enclosure of the cellphone and access to the power supply connection; and
means for provide power to the cell phone, electrically connected to said means for provide electrical connection for various cell phone models.

2. The cell phone mount in accordance with claim 1, wherein said means for support and recharging a cell phone with personalization comprises a personalized recharge unit.

3. The cell phone mount in accordance with claim 1, wherein said means for provide partial enclosure of the cellphone and access to the power supply connection comprises an interior cavity.

4. The cell phone mount in accordance with claim 1, wherein said means for provide electrical connection for various cell phone models comprises an interface plate.

5. The cell phone mount in accordance with claim 1, wherein said means for provide power to the cell phone comprises a power supply.

6. A cell phone mount for docking and recharging a cellphone comprising:
a personalized recharge unit, for support and recharging a cell phone with personalization;
an interior cavity, for provide partial enclosure of the cellphone and access to the power supply connection, structurally conformed to said personalized recharge unit;
an interface plate, for provide electrical connection for various cell phone models, directly fitted to said interior cavity; and
a power supply, for provide power to the cell phone, electrically connected to said interface plate.

7. The cell phone mount as recited in claim 6, further comprising:
a power cord, for connect electrical power to the power supply, electrically connected to said power supply.

8. The cell phone mount as recited in claim 6, further comprising:
a support mount, for support the personalized recharge unit to a vertical surface, lockingly coupled to said personalized recharge unit.

9. The cell phone mount as recited in claim 7, further comprising:
a support mount, for support the personalized recharge unit to a vertical surface, lockingly coupled to said personalized recharge unit.

10. A cell phone mount for docking and recharging a cellphone comprising:
a personalized recharge unit, for support and recharging a cell phone with personalization;
an interior cavity, for provide partial enclosure of the cellphone and access to the power supply connection, structurally conformed to said personalized recharge unit;
an interface plate, for provide electrical connection for various cell phone models, directly fitted to said interior cavity;
a power supply, for provide power to the cell phone, electrically connected to said interface plate;
a power cord, for connect electrical power to the power supply, electrically connected to said power supply; and
a support mount, for support the personalized recharge unit to a vertical surface, lockingly coupled to said personalized recharge unit.
